(19) United States
(12) Patent Application Publication
(10) Pub. No.: US 2017/0232348 A1
(43) Pub. Date: Aug. 17, 2017

(54) METHODS FOR EXECUTING AN INSTANCE OF A VIRTUAL MULTIPLAYER GAME AT MULTIPLE LOCAL DEVICES

(71) Applicant: Prizm Labs, Inc., Los Angeles, CA (US)

(72) Inventors: Brandon L. Williams, Los Angeles, CA (US); Michael A. Garrido, Los Angeles, CA (US); Jimmy A. Chen, Los Angeles, CA (US)

(21) Appl. No.: 15/425,730

(22) Filed: Feb. 6, 2017

Related U.S. Application Data
(60) Provisional application No. 62/291,516, filed on Feb. 5, 2016.
(60) Provisional application No. 62/291,517, filed on Feb. 5, 2016.

(51) Int. Cl. A63F 13/79; A63F 13/22; A63F 13/50; A63F 13/27

(52) U.S. Cl. CPC A63F 13/79; A63F 13/27; A63F 13/22; A63F 13/50

(57) ABSTRACT

One variation of a method for executing an instance of a virtual multiplayer game includes: at a game console, receiving a selection for a game; identifying a group of players though peripheral devices wirelessly connected to the game console; identifying a particular player, in the group of players, exhibiting less experience with the game than other players in the group of players; rendering a virtual public game environment on the main display; at a first time, at a particular peripheral device associated with the particular player, issuing a prompt for a first game action based on a state of the virtual public game environment; at the game console, updating the virtual public game environment on the main display based on the first game action submitted by the particular player; and recording a milestone for the particular player according to the first game action.

### CROSS-REFERENCE TO RELATED APPLICATIONS

This application claims the benefit of U.S. Provisional Application No. 62/291,516, filed on 5 Feb. 2016, and U.S. Provisional Application No. 62/291,517, filed on 5 Feb. 2016, both of which are incorporated in their entireties by this reference.

### TECHNICAL FIELD

This invention relates generally to the field of gaming systems and more specifically to new and useful methods for executing an instance of a virtual multiplayer game at multiple local devices in the field of gaming systems.

### BRIEF DESCRIPTION OF THE FIGURES

FIG. 1 is a flowchart representation of a first method;

FIG. 2 is a flowchart representation of one variation of the first method;

FIG. 3 is a flowchart representation of one variation of the first method; and

FIG. 4 is a flowchart representation of a second method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Methods

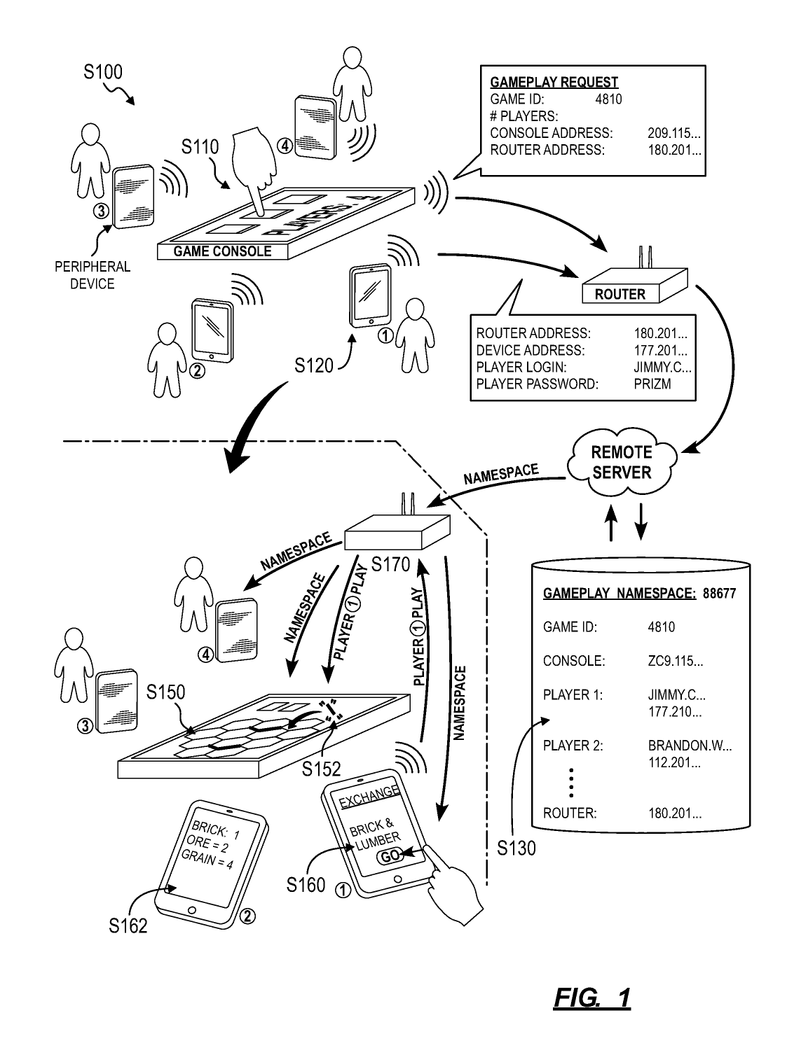

As shown in FIG. 1, a first method S100 for executing an instance of a virtual multiplayer game includes: at a game console comprising a main display, receiving a selection of a game from a set games in Block Silo; detecting a set of peripheral devices proximal the game console in Block S120; and associating each peripheral device in the set of peripheral devices with a player at the game console in Block S130. The first method S100 also includes, during an instance of the game (hereinafter a “gameplay”): rendering a virtual public game environment on the main display in Block S150; distributing a first set of private data to a first peripheral device for presentation on a display of the first peripheral device in Block S160, the first set of private data specific to a first player, the first peripheral device associated with the first player; distributing a second set of private data to a second peripheral device for presentation on a display of the second peripheral device in Block S162, the second set of private data specific to a second player and unique to the first set of private data, the second peripheral device associated with the second player; during a turn assigned to the first user, receiving a play submitted by the first user at the first peripheral device in Block S170; and updating the virtual public game environment rendered on the main display based on the play in Block S152.

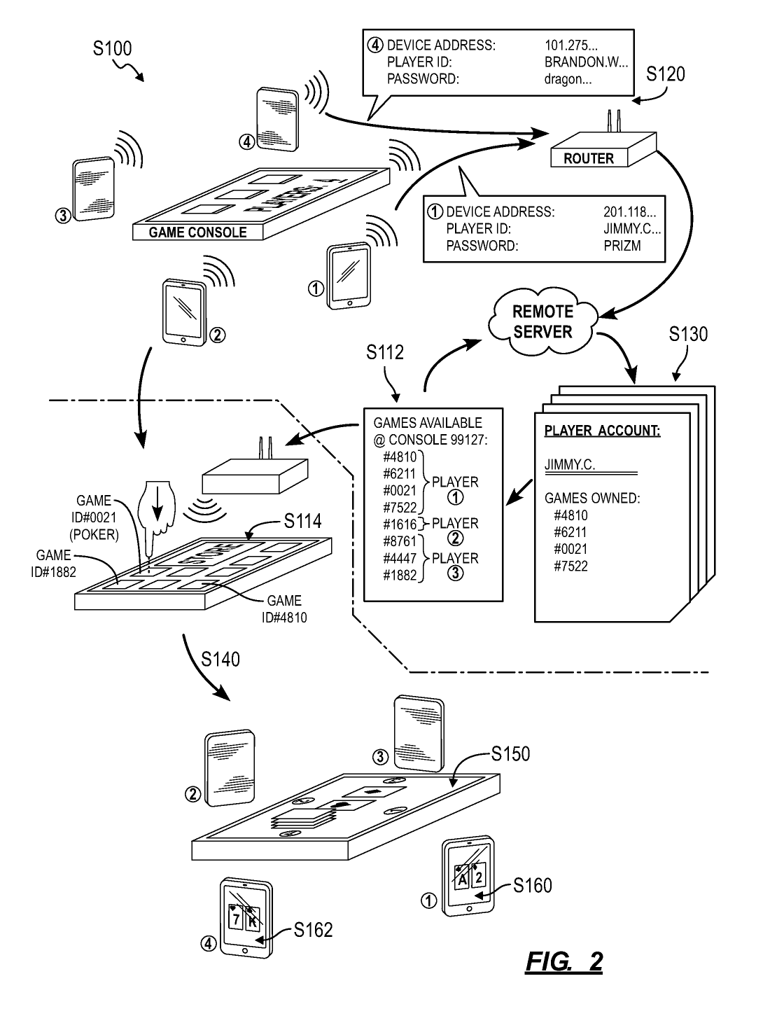

As shown in FIG. 2, one variation of the first method S100 includes: at a game console, detecting a set of peripheral devices proximal the game console in Block S120; accessing a player account based on player identification data received from each peripheral device in the set of peripheral devices in Block S130; for peripheral devices in the set of peripheral devices, aggregating sets of games linked to corresponding player accounts into a composite set of available games in Block S112; at the main display, prompting selection of a game from the composite set of available games in Block S114; in response to receiving a selection for a particular game in the composite set of available games, initiating an instance of the particular game at the game console and at peripheral devices in the set of peripheral devices in Block S140; presenting private player data for the particular game to select players through corresponding peripheral devices in the set of peripheral devices in Block S160; and presenting public game data within a virtual public game environment rendered on the main display in Block S150.

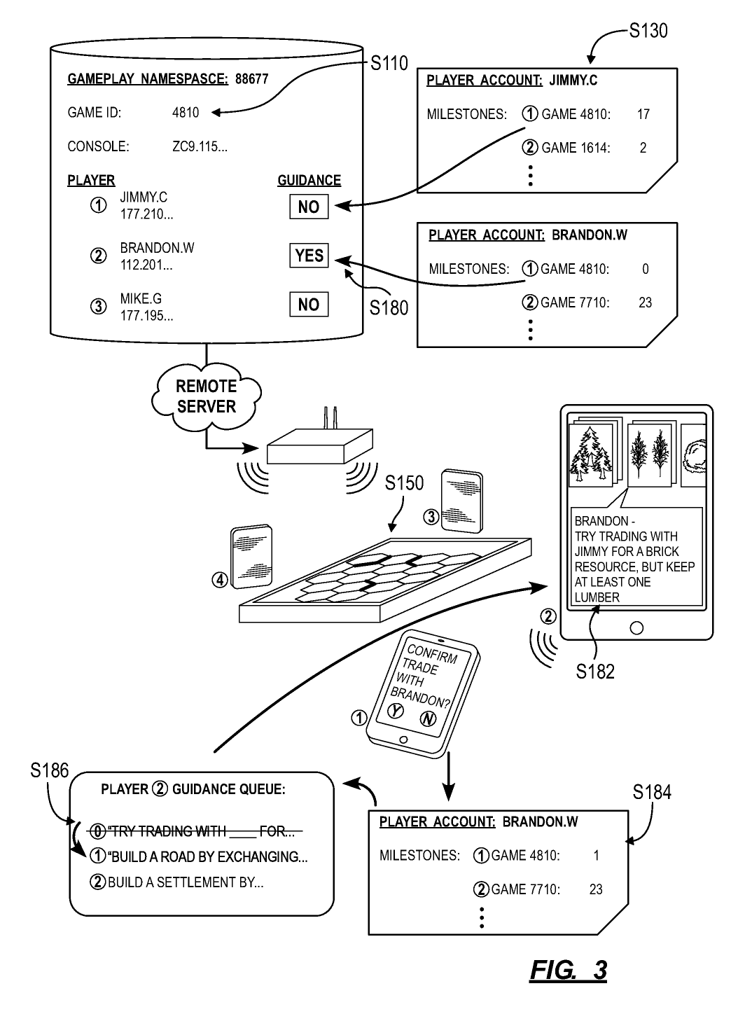

As shown in FIG. 3, another variation of the first method S100 includes: at a game console, receiving a selection for a game in Block Silo; identifying a group of players though a set of peripheral devices in communication with the virtual game console in Block S130; identifying a particular player, in the group of players, exhibiting less experience playing the game than other players in the group of players in Block S180; rendering a virtual public game environment on the main display in Block S150; at a first time, at a particular peripheral device associated with the particular player, issuing a prompt for a first game action based on a state of the virtual public game environment in Block S182; at the game console, updating the virtual public game environment on the main display based on the first game action submitted by the particular player in Block S152; in response to submission of the first game action by the particular player, recording a milestone for the first game action in Block S184; and, at a second time succeeding the first time, withholding a prompt for the first game action from the particular player based on the milestone in Block S186.

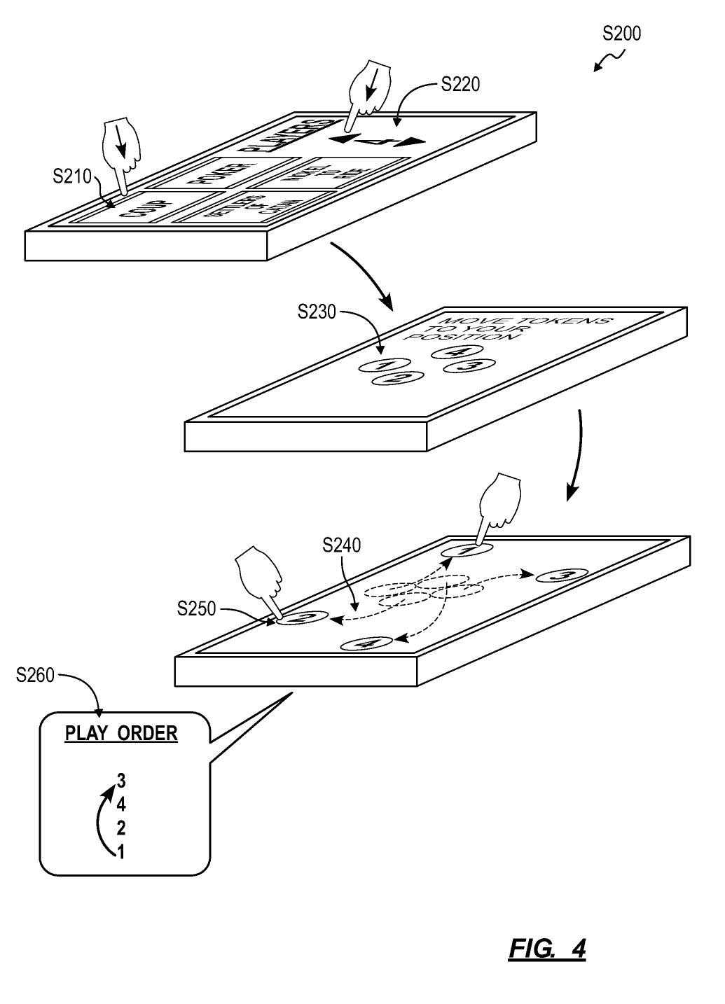

As shown in FIG. 4, a second method S200 for executing an instance of a virtual multiplayer game includes: at a game console comprising a main display, receiving a selection of a game from a set of games in Block S210; receiving a selection for a number of players in an instance of the game in Block S220; for each player in the number of players, rendering a virtual token linked to a player identifier on the main display in Block S230; detecting manual relocation of a particular virtual token, rendered on the main display, to a second position proximal a perimeter of the main display in Block S240; recording the second position of the particular virtual token as a play position of a player, associated with a particular player identifier and linked to the particular virtual token, around the game console in Block S250; and defining a turn order for the number of players during the instance of the gameplay based on positions of the tokens rendered on the main display in Block S260.

### 2. Applications

Generally, a game console can execute the first and second methods to receive a selection for a virtual game, to introduce players to an instance of the selected virtual game, to record physical positions of players around the game console, and to distribute public and private game data to players through the game console and peripheral devices uniquely associated with players in the game, respectively. In particular, the game console can include a main display at which a virtual public game environment is displayed and updated throughout a gameplay. Instances of a virtual private game portal can execute on peripheral devices associated with players of the game to enable these players to access and manipulate private content, such as private (e.g., personal) sets of virtual playing cards, virtual capital, and other virtual resources. Instances of the virtual private game portal and the game console can therefore selectively cooperate to distribute game content to appropriate audiences throughout a gameplay.

The game console can also detect and identify ID-enabled physical game pieces (hereinafter “ID-enabled physical objects”) placed on and moved about the main display by players and can update the virtual public game environment rendered on the display based on the “plays.” The game console can therefore augment real, physical objects placed on the main display with virtual media and audio. An instance of the virtual private game portal executing on a player's peripheral device can similarly: cooperate with a sensor within the peripheral device to detect and identify a physical object placed on or near the peripheral device; introduce a virtual object or other virtual resource linked to the physical object into the instance of the game; and/or enable a user to upgrade or modify a virtual object or other virtual resource linked to the physical object locally at the player's peripheral device, such as through an online store or online configurator, thereby preserving privacy of such game actions until the player is ready to play the virtual object within the virtual public game environment and limiting congestion of virtual content rendered on the main display.

The game console, instances of the virtual private game portal, and/or a remote database (i.e., a “system”) can also cooperate to distribute guidance to select players during a gameplay, such as for players who have not played the selected game or who have much less experience than other players at the game console, in order to permit the players to jump into playing an instance of the game without any or without significant manual description of the rules of the selected game and in order to achieve more equal chances of winning the instance of the game among its players despite differences in experience playing the game. For example, an instance of the virtual private game portal—executing on a peripheral device linked to a player—can serve prompts to make a play, descriptions of game rules, explanations of plays made by other players, etc. during a gameplay based on the player's skill level and experience playing the game. In this example, the game console can also cooperate with the instance of the virtual private game portal to provide guidance to the player, such as to suggest a play to the player within the virtual public game environment rendered on the main display during the player's turns throughout the gameplay.

### 3. Game Console

Generally, the game console contains a main display that functions as a physical public portal through which virtual games may be selected, through which virtual public game environments and public media (e.g., audio and visual content) is presented to players, and at which ID-enabled physical objects may be manipulated by players to control virtual objects within virtual public game environments during a gameplay. For example, the game console can include: a main display; a touch sensor coupled to the main display configured to detect contact within the main display, such as by a physical game piece or by a player's finger; a wireless communication module configured to communicate game data to and from a remote server; and a physical object sensor unit (e.g., a set of RFID readers) configured to collect IDs from ID-enabled physical objects placed on the main display during a gameplay. However, the game console can define any other physical form and can include any other wireless communication modules, sensors, etc. supporting communication with adjacent ID-enabled physical objects, peripheral devices, and a remote server or database during gameplays.

### 4. Virtual Private Game Portal

An instance of the virtual private game portal can be accessed through a wireless-enabled peripheral device, such as through a personal smartphone, personal tablet, a personal media player, or any other suitable type of mobile computing device owned by or shared with a player. Alternatively, the virtual private game portal can be accessed through a console-specific computing device configured to interface specifically with the game console and/or with a remote server hosting namespaces and other data gameplays executed at the game console.

The virtual private game portal can be hosted within a web browser, within a native generic gaming application, and/or within a native game-specific application executing on a peripheral device. In one implementation, an host for the virtual private game portal is selected at a peripheral device in preparation for an upcoming gameplay at a game console based on: an amount of private information shared with players during a gameplay of a selected game; a number and/or type of gesture controls at a peripheral device supported for the selected game; private animations for virtual objects defined in the game; effect of access to player account information during one gameplay and across multiple gameplays of the selected game; and/or type(s) of host currently installed on the peripheral device; etc. For example, for a virtual poker game in which only a private hand of two cards from a 52-card deck are shown at any time on a peripheral device, the virtual poker game can include a specification for default access to an instance of the virtual private game portal at a peripheral device through a web browser since the poker game may require a relatively limited number of possible user inputs and require no customization of virtual objects or content within a virtual poker game environment. However, if a native generic game application or a native poker-specific application is executing on the peripheral device, the peripheral device can access the virtual private game portal through such a native application in order to enable additional gestures, access additional animations, record rounds for later replay, etc. at the peripheral device during a gameplay of poker.

In another example, for a virtual strategy game with generic characters and standardized virtual resources in which a player assembles various combinations of virtual resources and trades virtual resources with other players in order to progress through the gameplay, the virtual strategy game can include a specification that disallows access to an instance of the virtual private game portal through a web browser and that instead sets default access to the virtual private game portal through a native generic game application. In this example, if the native generic game application is not loaded onto a peripheral device upon selection of the strategy game at the game console, the game console of the remote server can automatically push a prompt to load the native generic game application to the peripheral device based on such a specification for the strategy game in order to allow the strategy game to be played with the peripheral device. However, in this example, if the peripheral device is loaded with a native application specific to the selected strategy game, the peripheral device can serve the virtual private game portal through this native application specific to the selected strategy game.

In yet another example, for a media-rich virtual game in which players may customize virtual characters, modify actions performed by virtual characters and virtual objects, combine virtual characters and virtual objects to access additional actions, access histories of characters linked to their own ID-enabled physical objects, etc., the media-rich game can include a specification that disallows access to an instance of the virtual private game portal through a web browser or through a native generic game application and that instead sets exclusive access to the virtual private game portal for the media-rich game through a native game-specific application for the media-rich game. If the peripheral device selected by a player is a console-specific peripheral device not currently loaded with the native game-specific application, the peripheral device can automatically download the native game-specific application from the remote server upon selection of the media-rich game. Alternatively, if the peripheral device selected by a player is a personal peripheral device (e.g., a smartphone) not currently loaded with the native game-specific application, the remote server and/or the game console can push a prompt to the personal peripheral device to download the native game-specific application to the personal peripheral device and confirm its installation before initiating a gameplay with the game console and the personal peripheral device. The native game-specific application can thus enable a high degree of customization of virtual objects, enable purchase of additional virtual content (e.g., character upgrades), and otherwise provide a relatively highly-immersive experience during play of the media-rich game.

A virtual private game portal can therefore be specific to the game selected for play, and the game console, remote server, and virtual private game portal can therefore gate games or gate entry into a gameplay for a player based on types of peripheral devices selected by players and based on portal access enabled at these peripheral devices. However, an instance of the virtual private game portal can be accessed through any other host in any other way at a peripheral device.

### 5. Game Selection and Player Identification

Block S110 of the first method S100 (and Block S210 of the second method S200) recites, at a game console comprising a main display, receiving a selection of a game from a set of games. Generally, the game console (and/or one or more peripheral devices linked to the game console) can execute Block S110 to receive a selection for a game to play at the game console.

In one example implementation, upon starting a game console, a user (e.g., the owner of the game console) logs into her player account through the main display at the game console. The game console then renders a virtual portal to available virtual games on its main display, such as including: games previously purchased at the game console; paid and/or free games previously played at the game console; and/or a game store or library through which additional paid or free games can be accessed or purchased by the user and other players physically present at the game console, as described below. For example, the game console can retrieve virtual cover art for each game available for play at the console from a remote database, render these virtual cover art on the main display, and prompt selection of a particular game from the set of available games by tapping the main display over a corresponding virtual cover art. Alternatively, the user can login to her player account within a web browser or native game application executing on a peripheral device linked to the game console in order to access a virtual private game portal, the virtual private game portal can implement similar methods and techniques at the peripheral device to present games available for play at the game console and receive a selection from these games and can then pass this selection to the game console, such as by transmitting this selection directly to the game console or by routing the selection to a remote server accessible by the game console. The game console can then retrieve a specification, rule set, and/or media (e.g., virtual static images, virtual animations, audio files), etc. for the selected game. For example, the game console can download this game specification from a remote database or access the game specification from local memory, such as if the game was previously purchased and stored locally at the game console.

In the foregoing example implementation, if the specification for the selected game indicates that the game is not a perfect information game (i.e., a game in which some gameplay data is specific to a subset of players and hidden from other players), the game console can prompt players at the game console to link peripheral devices to the game console before initiating an instance of the selected game. As players access peripheral devices and link their peripheral devices to the game console, the game console can: detect peripheral devices proximal the game console in Block S120; identify a player at the game console via her peripheral device in Block S130; and can then serve private game data to this player via her peripheral device throughout the subsequent gameplay in Block S160.

In one implementation in which the selected game specifies a peripheral device for a player during a gameplay of the selected game, the game console can: receive entry of a number of players in the game at the main display in Block S220; and pass an IP address of a local wireless router to which the game console is wirelessly connected, an identifier of the selected game, the number of players for the game, and a request for a namespace for the upcoming gameplay. Upon receipt of these data, the remote server can generate a temporary namespace for the upcoming gameplay of the selected game. For example, the temporary namespace: can be assigned to an unique gameplay ID and to the game console (e.g., to the game console's IP address); can contain a table of IDs of ID-enabled physical objects associated with the game console, associated with a player logged into the game console, associated with a virtual object (e.g., a virtual character, a virtual environment object, etc.) within the game, and/or appropriate for temporary pairing with a virtual object within the game; can contain links or pointers to virtual resources (e.g., audio files, visual content); can include gameplay rules, definitions of interactions between virtual objects within a virtual game environment, and definitions of relationships between virtual objects and ID-enabled physical objects; etc.

In this foregoing implementation, when a player proximal the game console accesses a virtual private game portal at her peripheral device, such as through a web browser, a native generic game application, or a native game-specific application), the virtual private game portal can pass an IP address of a local wireless router to which the peripheral device is wirelessly connected and pass this IP address and a request to join a local game to the remote server. Based on like wireless router IP addresses received from the game console and the peripheral device at similar times (e.g., within a threshold duration of five minutes of the game selection), the remote server can pair the player's peripheral device with the game console. For example, the remote server can assign the temporary namespace for the gameplay to game console's IP address and write an IP address of the player's peripheral device to the temporary namespace for the gameplay. Based on this link between the player's peripheral device and the game console, the instance of the virtual private game portal executing on the player's peripheral device can access gameplay data and present private data to the player through the player's peripheral device, and the game console can receive plays and/or play configuration data from the player's peripheral device and update the main display accordingly throughout the gameplay associated with the temporary namespace.

The remote server can implement the foregoing process to populate the temporary namespace with a link to one unique peripheral device for each of the number of players specified for the gameplay. In particular, the remote server can execute Block S130 of the first method S100 to associate each peripheral device—in the set of peripheral devices wirelessly connected to the same wireless router as the game console—with a player at the game console. Once each player position in the temporary namespace is linked to a peripheral device, the remote server can transmit confirmation to the game console that all players are present.

Furthermore, if the selected game does not require access to player accounts to play the gameplay (or if players at the game console decline to login to personal game accounts at their corresponding peripheral devices), the game console can initiate the gameplay, such as by executing Blocks of the second method S200 described below to set positions of the players around the game console and rendering a virtual public game environment on the main display in Block S150 as virtual private game data is displayed on corresponding peripheral devices in Blocks S160 and S162, as described below.

### 6. Identifying Players

In the foregoing implementation, if the selected game requires access to player accounts, such as to access virtual characters previously customized by the player or resources previously collected by the user during a physical/virtual trading card game, the system (e.g., the game console, instances of the virtual private game portal, the remote server) can prompt the group of players to access their player accounts through their corresponding peripheral devices. For example, if a specification for the selected game specifies a preference or requirement for access to player accounts, each virtual private game portal executing on a peripheral device linked to the game console can automatically prompt its corresponding player to enter a username and password in order to access her player account; once a player account is thus accessed in Block S130, the system can write data to the player account based on actions within the virtual game environment and can read data from the player account, such as to define the player's virtual characters within the virtual game environment, throughout the gameplay.

In another example, to login to her personal player account, a player can tap an ID-enabled physical object (e.g., a physical character with integrated RFID tag) onto her peripheral device, and an instance of the virtual private game portal executing on the peripheral device: can cooperate with a sensor within the peripheral device to read an ID from the physical object; can pass the physical object's ID to the remote server that retrieves an ownership ID for the physical object's ID and serves player account information back to the peripheral device; and can automatically open the player's account, such as upon entry of a password into the peripheral device, in Block S130. Alternatively, the player can place the physical object on the game console, and the game console and the remote server can implement similar methods and techniques to identify the player based on the physical object's ID and to serve a prompt to peripheral devices currently linked to the game console in Block S130 to access the corresponding player account. In this example, a virtual private game portal executing on a peripheral device can then link the player account to the peripheral device in response to selection of the prompt and entry of an access code, PIN code, or password. Therefore, in this example, the game console and/or the peripheral devices can populate a players list based on ID-enabled physical objects placed on the main display and can enable players to select virtual objects corresponding to these physical objects and to access their player accounts through these physical objects.

In yet another example in which a player elects an ID-enabled peripheral device (e.g., an NFC or RFID-enabled smartphone) previously linked to the player's account, the player can tap her peripheral device on the main display of the game console to link her peripheral device and her player account to the upcoming gameplay. For example: the game console can read an ID from the peripheral device upon contact between the peripheral device and the game console and then pass the peripheral device's ID to the remote server; and the remote server can retrieve a player account linked to the peripheral device's ID, write the peripheral device's ID to the temporary namespace for the upcoming gameplay, and then push a prompt to automatically open the player's account and a virtual private game portal for the selected game to the player's peripheral device. In this example, the game console can also record a location on the main display on which an ID-enabled peripheral device is placed to download a peripheral device ID to the game console (or to upload a game console ID to the peripheral device), and the game console can associate this location on the main display with the corresponding player's physical position around the main display throughout the duration of the upcoming gameplay or until the player enters an alternate position on the main display, as described below. Furthermore, the game console can automatically set the order in which players in the group enter their turns during the gameplay based on these positions, such as by writing these positions to the temporary namespace, and instances of the virtual private game portal can automatically activate and deactivate their corresponding players' turns based on this order throughout the gameplay.

Alternatively, the game console can implement similar methods and techniques to generate temporary namespaces for gameplays locally, and peripheral devices can communicate directly with the game console (e.g., rather than through a wireless router and the remote server), such as via a short-range wireless communication protocol.

### 7. Game Selection Variation

In the variation in which players access personal player accounts through peripheral devices linked to the game console (e.g., directly via short-range wireless communication protocol or via a remote server), the system can also: aggregate sets of games linked to player accounts into a composite set of available games in Block S112; and prompt players to select a game from the composite set of available games in Block S114. Generally, players currently playing at the game console may have previously purchased games outside of the current group of players or may have otherwise linked games to their player accounts. The system can therefore execute Blocks S112 and S114 to identify these games from the player's accounts, aggregate these games into a list of games available for play at the console, and then enable the players to select a game from this list to play, such as at the game console or through the players' peripheral devices. Therefore, though a particular paid game has not been purchased at the game console, purchased by an owner of the game console, or previously played at the game console, the system can allow players at the game console to select and play the particular game—without again purchasing the particular game—if at least one player at the game console has previously purchased the particular game or a seat to the particular game according to Blocks S112 and S114, as shown in FIG. 2.

Furthermore, for a game thus selected for play at the game console but for which one or more ID-enabled physical objects linked to virtual objects within the selected game are not physically present at the game console, the system can temporarily pair other ID-enabled physical objects—currently present at the game console but not associated with virtual objects of the selected game—with virtual objects of the selected game, such as by generating temporary namespaces linking IDs of these physical objects to virtual objects for the duration of the upcoming gameplay based on inputs entered by the group of players at their peripheral devices and/or at the game console. The system can therefore also enable the group of players to play a selected game even if ID-enabled physical objects originally linked to the selected game are not immediately available.

### 8. Player Position

The system can also execute Blocks of the second method S200 to record positions of players around the game console. In one implementation, the system determines a number of players for the upcoming game position in Block S220, such as by prompting selection of a player number—between a minimum player number and a maximum player number for the selected game—at the main console or by automatically determining the number of players for the selected game based on a number of peripheral devices detected near the game console or based on a number of player account logins at peripheral devices near the game console. In this implementation, for each player in the number of players selected or determined for the upcoming gameplay, the game console can render a virtual token linked to each player identifier on the main display in Block S230. For example, for a virtual poker game for which players do not log into personal player accounts at their peripheral devices, the game console can render a number of generic colored tokens equal to the number of players on the main display in Block S230, and each virtual private game portal executing on a peripheral device at the game console can highlight a color corresponding to one virtual token to indicate to the corresponding player which token has been assigned to her.

In another example, prior to initiation of a gameplay, players can select or construct virtual avatars at their peripheral devices, the virtual private game portals can write values for these virtual avatars to the temporary namespace for the gameplay, and the game console can populate the main display with these virtual avatars in Block S230, such as in a cluster around the center of the main display as players swipe virtual avatars shown in screens of their peripheral devices toward the main display. The game console can then prompt players at the game console to drag their corresponding tokens or avatars to positions at the perimeter of the main display nearest their real positions around the game console. Thus, in Block S240, the game console can detect manual relocation of a particular virtual token, rendered on the main display, to a second position proximal a perimeter of the main display, store this location as the corresponding player's position around the game console in Block S250, and repeat this for each other player at the game console. Finally, the game console (or the remote server, etc.) can define a turn order for the players during the subsequent gameplay in Block S260 based on positions of the tokens or avatars around the perimeter of the main display and the identities of their corresponding players, as shown in FIG. 4. For example, the system can cycle turns among players at the game console by indexing in a clockwise fashion through player tokens or avatars positioned on the main display.

However, the system can implement any other method or technique to determine player positions around the main console.

### 9. Initiating a Gameplay

Once the game is selected, players are logged into their player accounts, and positions of players are thus determined around the game console, the system can initiate an instance of the selected game at the game console and at peripheral devices in Block S140. For example: the game console can render a virtual public game environment on the main display in Block S150; instances of the virtual private game portal executing on the players' peripheral devices can present private game data to the players; the game console and the instances of the virtual private game portal can selectively prompt and permit players to enter plays into the virtual game environment according to rules of the game; and the game console can update the virtual public game environment rendered on the main display according to plays entered by players in Block S152.

Throughout the gameplay, the game console and the local peripheral devices can communicate game data directly or indirectly through a local wireless router. Alternatively, the game console can upload game data to the remote server via a local wireless router, and the remote server can route these data back to peripheral devices at the game console, such as via the Internet and the local wireless router or via a cellular tower; and vice versa. For example, the game console can maintain a local master copy of the temporary namespace for the gameplay and distribute complete copies of this temporary namespace to local peripheral devices linked to the gameplay (e.g., by uploading to the peripheral devices via the local wireless router) such that the peripheral devices maintain access to the current state of the gameplay. In this example, when a play is submitted by a player, the player's peripheral device can update its local copy of the temporary namespace and pass this back to the game console, which then distributes this updated temporary namespace to the other peripheral devices at the game console. Alternatively, as players configure plays, submit plays, introduce virtual objects, etc. into the virtual game environment, these peripheral devices can upload such data to the game console (e.g., via the local wireless router), and the game console can update its local copy of the temporary namespace as these data are received before updating copies of the temporary namespace on these peripheral devices. The peripheral devices and the game console can therefore store complete local copies of the temporary namespace (or other form of database for the gameplay) throughout the gameplay.

### 10. Public and Private Game Views

During an instance of the game (i.e., a “gameplay”) the system can: render a virtual public game environment on the main display in Block S150; distribute a first set of private data to a first peripheral device for presentation on a display of the first peripheral device in Block S160, wherein the first set of private data is specific to a first player and the first peripheral device is associated with the first player; and distribute a second set of private data to a second peripheral device for presentation on a display of the second peripheral device in Block S162, wherein the second set of private data is specific to a second player and unique to the first set of private data, and wherein the second peripheral device is associated with the second player.

Generally, an instance of the virtual private game portal executing on a player's peripheral device can: present private virtual content to the player, such as cards dealt to the player, game resources (e.g., virtual brick resource cards and virtual grain resource cards) collected by the player, virtual characters and upgrades under the player's control, etc.; can enable the player to collect additional resources from other players and/or from a resource bank; can enable the player to privately configure this virtual content into a play; and can upload details of a play submitted by the player to the system (e.g., to the remote server, directly to the game console) in Block S170. The game console can then update the virtual public game environment based on the player's play, and the system (e.g., the remote server) can push updated gameplay data to instances of the virtual private game portal executing on other players' peripheral devices before permitting a next player to submit a play, as shown in FIG. 1.

An instance of the virtual private game portal executing on a player's peripheral device can therefore function as a portal through which the player may view private game data, configure a play, and submit a play to the virtual public game environment shown in the main display of the game console. An instance of the virtual private game portal also functions to serve private game data to its corresponding player and to the exclusion of other players at the game console. For example, an instance of the virtual private game executing on a player's peripheral device can enable the player to control visual access to her private game data by keeping the screen of her peripheral device private or by showing the screen of her peripheral device to select players at select moments during the gameplay for strategic reasons or to enable another player to draw a virtual card from her virtual hand of cards.

However, the game console functions to present public data for the gameplay to the group of players. For example, the main display in the game console can render: a virtual representation of a game board, positions of virtual objects (e.g., tokens, characters) placed by players onto the virtual game board (e.g., by placing corresponding ID-enabled physical objects onto the main display); and virtual resources publicly available to players within the virtual game environment; etc. in Block S150. Therefore, an instance of the virtual private game portal can present a virtual representation of physical cards, game resources, and/or game pieces held privately by a player and can handle submission of plays privately configured by the player during the gameplay; and the game console can present a virtual representation of a game board for visual consumption by all players and can update the virtual representation of a game board during a gameplay based on plays submitted by these players through their peripheral devices.

### 11. Gestures

Throughout a gameplay, the game console and instance of the virtual private game portal executing on players' peripheral devices can cooperate to manipulate and distribute virtual resources within the virtual game environment based on gestures entered by players in their peripheral devices.

In one example, during a gameplay of a virtual poker game, an instance of the virtual private game portal can render a hand of virtual cards dealt to a player. In this example, the system can record a check call for the player when the player double-taps the screen of his peripheral device or taps the main display of the game console. When the player gently swipes his virtual hand of cards toward the top of the screen on his peripheral device—and toward the game console in front of the player—the peripheral device can record that the player has quietly folded, and the game console can update the virtual public game environment rendered on the main display to show the player's virtual hand moving face down toward the center of the main display. However, when the player rapidly swipes his virtual hand of cards toward the top of the screen on his peripheral device, the peripheral device can record that the player has indignantly folded, and the game console can animate the virtual public game environment to show the player's virtual hand scattering across the virtual game board. Furthermore, when the player tosses his peripheral device face-up onto a table—such as determined from motion sensors within the peripheral device—the peripheral device can record that the player has aggressively folded, and the game console can show the virtual public game environment shaking on the main display with the player's virtual cards tumbling across the virtual table and landing face-up. Similarly, when the game console automatically deals a card to a player, the main display can animate motion of a virtual card moving from a virtual dealer to an edge of the main console associated with the position of the corresponding player, and the player's peripheral device can then animate motion of the virtual card from the edge of its secondary display to the player's virtual hand of cards. The system can therefore record gestures entered by a player at his peripheral device and enter a play into the gameplay and update the virtual physical game environment based on such gestures.

In another example, an instance of the virtual private game portal executing on a player's peripheral device can enable the player to share or transfer a virtual resource from his virtual private game portal to another player at the game console. For example, a first player's virtual private game portal can detect selection of a virtual object shown on the first player's peripheral device and then move the virtual object to a second player to the first player's right—such as determined from the placement of player-assigned tokens on the main display—as the first player swipes the selected virtual object toward the right edge of his peripheral device. In this example, instances of the virtual private game portal executing on the first and second players' peripheral devices can also animate this transfer, such as based on the speed at which the first player swipes his finger across his peripheral device.

However, the system can implement any other methods or techniques to detect and handle gestures entered at peripheral devices and/or at the game console during a gameplay.

### 12. Audio

The game console and instances of the virtual private game portal can cooperate to distribute and replay audio content during a gameplay. For example, when a player swipes a virtual object from her peripheral device toward the game console, the player's peripheral device can replay—through its integrated speaker—an audio resource linked to the virtual object and fade out this audio resource as the game console fades in the remainder of the audio resource—through its own integrated speaker(s)—in order to audibly indicate transfer of the virtual object from the player's peripheral device to the main console; in this example, the main console can also update the virtual public game environment rendered on the main display to include the virtual object thus played by the player.

In a similar example, during a player's turn, the main console can detect and identify placement of a generic ID-enabled physical object or an ID-enabled physical object associated with the player on the main display. In this example, the player's peripheral device can similarly replay an audio resource linked to the physical object (or to a virtual object associated with the physical object's ID) and fade out this audio resource as the game console fades in the remainder of the audio resource, thereby audibly indicating placement of the physical object onto the game console by a player. In this example, the main console can similarly update the virtual public game environment to show a virtual object associated with the physical object, such as in the form of a static image or animation rendered on the main display under the physical object.

The system can similarly replay audio content at two peripheral devices to indicate transfer of virtual resources from a player at one peripheral device to a player at the other peripheral device.

In yet another example, a first player interfaces with an instance of the virtual private game portal executing on his peripheral device to configure a virtual dragon to direct a fireball toward a virtual wizard character associated with a second player at the game console and then taps an ID-enabled physical dragon character onto the main console. Upon detecting and identifying the physical dragon character on the main display, the game console can retrieve audio content for a dragon play and fireball from the remote server, peripheral devices at the game console can similarly download the audio content, and the game console and peripheral devices can cooperate to fade in and fade out replay of the audio based on the stored positions of corresponding players around the game console in order to provide an audible perception of a dragon flying around the game console and directing a fireball toward a region on the main display at which the second player's virtual wizard (and a corresponding physical wizard) is currently positioned. The main display can also render an animation of the virtual dragon flying about its perimeter and synchronized to the audio content replayed at the peripheral devices. The main display can also render a virtual fireball directed toward the virtual wizard and visually animate impact of the virtual fireball with the virtual wizard while replaying a corresponding audio track.

However, the system can implement any other methods or techniques to replay audio content and to synchronize such audio content with corresponding visual content.

### 13. Game Purchase

In one variation, the game console presents a virtual game store and enables players at the game console to select and purchase a new game from the virtual game store. In this variation, the system can collect payment for the game from one or more players at the game console and then write authorization to access this purchased game to player accounts of these players such that these players may access and play the purchased game at later times, such as at the same or different game console and with the same or different group of players. However, the system can limit access to the purchased game to a single gameplay (or “seat”) of the purchased game at any one time. A particular player in this group can therefore “checkout” the seat for the purchased game and play the purchased game with other players at another game console at a later date, and the system can reject access to this seat for others players in the original group—now playing at other games consoles—until the particular player is no longer using the seat.

However, the system can implement any other methods and techniques to support and handle a game purchase among a group of players.

### 14. Physical and Virtual Game Objects

An instance of the virtual private game portal executing on a player's peripheral device can function to detect and identify an ID-enabled physical object placed in contact therewith and to introduce a virtual object—linked to the physical object's ID—into the virtual game environment. For example, the peripheral device can include an RFID reader configured to download an ID from an RFID tag integrated into an ID-enabled physical object, and the virtual private game portal executing on the peripheral device can pass this physical object's ID and an ID of the game in process to the remote server. In this example, the remote server can retrieve audio and/or visual media for a virtual object linked to a physical object's ID and to the game ID and pass these media back to the player's peripheral device and/or to the game console. The virtual private game portal can thus enable a player to retrieve virtual media by physically interfacing an ID-enabled physical object with her peripheral device and can then enable the player to configure and submit a play with this new media (e.g., a virtual character, a virtual environment object, a virtual character power or upgrade, etc.) into the virtual game environment. The game console can implement similar methods and techniques when an ID-enabled physical object is placed on the main display.

The virtual private game portal can also enable a player to directly access virtual objects associated with the player's account, such as virtual objects associated with the game currently in process. For example, if players at the game console select a game in which players battle virtual characters owned by the players and linked to ID-enabled physical character objects owned by the players, but if a particular player at the game console does not currently have access to her ID-enabled physical character objects, an instance of the virtual private game portal executing on the particular player's peripheral device can access her virtual characters regardless in order to enable the particular player to play the game despite lack of access to her ID-enabled physical character objects. In this example, the instance of the virtual private game portal executing on the particular player's peripheral device can also enable the particular player to temporarily link other ID-enabled physical character objects to her virtual characters, such as ID-enabled physical objects from other games or ID-enabled physical objects loaned by other players at the game console—by writing links between a virtual character and an ID of a physical object in the temporary namespace for the current gameplay—in order to enable the particular player to manipulate her virtual characters within the virtual game environment with ID-enabled physical objects throughout the current gameplay.

In another example, a peripheral device interfacing with the game console can emulate an ID-enabled physical object, such as if the ID-enabled physical object is not present at the game console. For example, an instance of the virtual private game portal executing on a player's peripheral device can receive an input from the player that one or more ID-enabled physical objects linked to the player's account are not presently available. In response to selection of a particular virtual object—corresponding to a physical object not currently present—at the peripheral device, the instance of the virtual private game portal can access a wireless ID stored on the peripheral device (e.g., a RFID, UUID) and transmit a prompt to the remote server (or to the game console) to overwrite a physical object ID linked to the particular virtual object with the wireless ID of the peripheral device. (Alternatively, the instance of the virtual private game portal can link the virtual object to the wireless ID of the peripheral device locally.) Subsequently, when the player places the peripheral device on the main display, the game console can read the wireless ID from the peripheral device and respond to receipt of this wireless ID by introducing the particular virtual object into the virtual game environment as if the ID-enabled physical object linked to the particular virtual object had been placed on the game console. In this example, the instance of the virtual private game portal can render an image of the particular virtual object on the peripheral device's integrated screen to indicate the current link between the peripheral device and the particular virtual object. Throughout the gameplay, the instance of the virtual private game portal can also enable the player to remove the link between the peripheral device and particular virtual object and to temporarily link the peripheral device to another virtual object corresponding to another ID-enabled physical object. However, the peripheral device can function to temporarily emulate an ID-enabled physical object in any other way.

However, the virtual private game portal and the physical game portal can implement any other methods and techniques to introduce physical and virtual objects to the virtual game environment, to access virtual objects corresponding to a player's ID-enabled physical objects, and/or to temporarily link other ID-enabled physical objects to a player's virtual objects.

### 15. Guidance

The system can also execute a method for selectively guiding players during a game, including; at a game console, receiving a selection for a game in Block S110; identifying a group of players through a set of peripheral devices in communication with the virtual game console in Block S130; identifying a particular player, in the group of players, exhibiting less experience playing the game than other players in the group of players in Block S180; rendering a virtual public game environment on the main display in Block S150; at a first time, at a particular peripheral device associated with the particular player, issuing a prompt for a first game action based on a state of the virtual public game environment in Block S182; at the game console, updating the virtual public game environment on the main display based on the first game action submitted by the particular player in Block 152; in response to submission of the first game action by the particular player, recording a milestone for the first game action in Block S184; and, at a second time succeeding the first time, withholding a prompt for the first game action from the particular player based on the milestone in Block S186, as shown in FIG. 3.

Generally, in this variation, the game console, an instance of the virtual private game portal executing on a player's peripheral device, and/or the remote server can cooperate to: track player milestones during a gameplay; and to generate real-time guidance for a player based on the player's milestone status, the player's game positions, and/or positions and experience of other players at the game console, etc. The instance of the virtual private game portal executing on the player's peripheral device can then present such guidance to the player substantially in real-time during the gameplay in order to achieve more equal chances of winning the gameplay among the group of players despite differences in levels of experience playing the game among a group of players.

In one example, the game console receives selection of a game in which players collect game resources based on values shown on rolled dice, exchange game resources for placement of pieces on a game board, and win based on numbers of pieces played. In this example, as players at the game console login to personal player accounts on peripheral devices connected to the game console (e.g., directly or indirectly through a local wireless router), the remote server can scan histories of players playing the game to determine which players in the group have previously played the selected game. If a significant difference in experience playing the selected game exists between players in the group—such as if player accounts indicate that no recorded milestones for the game have been achieved by a new player in the group but that all milestones have been achieved by a second player in the group—the remote server can activate private guidance for the first player in Block S180, such as by writing a call to provide guidance to the first player in the temporary namespace for the upcoming gameplay of the selected game, as shown in FIG. 3. In this example, the virtual private game portal can also prompt the first player to confirm that she wishes to receive such guidance during the gameplay before the system activates such selective guidance for the gameplay.

During a gameplay of the selected game in the foregoing example, the system can automatically distribute a virtual grain resource and a virtual lumber resource to the first player based on values of virtual dice rolled by the players at the game console. In order to enable the first player to subsequently place a virtual road in the virtual game environment, the virtual private game portal can issue a prompt to the first player to initiate a trade with another player who recently collected a virtual brick resource, including trading the first player's virtual grain resource for the other player's virtual brick resource, as shown in FIG. 3. The virtual private game portal can also provide reasoning for collecting the virtual brick resource, such as by presenting a notification that recites, “By collecting a brick resource, you may combine this brick with your existing lumber resource to purchase a road. You can then place this road, which allows you to place a new settlement during a later turn and score points” on the first player's peripheral device in Block S182. The system can enable the first player to trade with another player through her virtual private game portal, such as by receiving a player selection and a virtual resource for trade at the first player's peripheral device, receiving confirmation of the trade and selection of a virtual resource by another player through his peripheral device, and then redistributing virtual resources accordingly. Based on such a trade involving the first player, the system can record that the first player has achieved a trading milestone in Block S184, and the first player's virtual private game portal can later withhold trading prompts from the first player according to this recorded trading milestone in Block S186.

In this example, once the first player has collected a virtual brick resource, the first player's virtual private game portal can prompt the first player to exchange one virtual brick resource and one virtual lumber resource for a virtual road, and the system can highlight a position in the virtual game environment—such as on the first player's peripheral device and/or on the main display—suggesting a best position to place the new virtual road. Once the first player places the new virtual road in the virtual game environment, the game console can update the virtual public game environment to show the position of the new virtual road, and the system can record that the player has achieved a road purchase and placement milestone in Block S184 and later withhold road purchase and placement guidance from the first player in Block S186.

With the first player's virtual road now placed in the virtual game environment, the first player's virtual private game portal can suggest that the first player keep a virtual brick resource and a virtual lumber resource collected by the first player soon thereafter—rather than immediately exchange these virtual resources for a virtual road—in order to enable the first player to collect resources necessary to purchase and place a virtual settlement within the virtual game environment. Furthermore, the system can compare current placements of virtual roads, virtual settlements, and virtual cities within the virtual game environment to rules for the game to determine if the first player's current board position fulfills necessary requirements for purchasing and placing a new settlement. In this example, if the first player's current board position is not suitable for placing a new settlement, the first player's virtual private game portal can alternatively suggest that the first player immediately exchange his brick and lumber resources for another virtual road and suggest a position in the virtual public game environment to place this virtual road to enable the first player to purchase and place a settlement with a next virtual brick resource and next virtual lumber resource she collects. The system can therefore serve guidance to the players based on current context and/or state of the gameplay in progress, such as based on positions of other players in the game and short- and/or long-term strategies for winning the game.

In another example in which the same game is selected, the system can determine from player accounts of players entering a gameplay that no players in the group have played the selected game, and the system can activate guidance for all players in the group, such a described above. The system can thus present guidance to all players in the group, such as by shifting some private guidance to public presentation on the main display rather than private presentation on selected peripheral devices in order to increase access to information for the group of new players and to reduce an amount of time needed to expose players in the group to various plays and strategies for winning the game. Furthermore, in this example, as new players in this group advance throughout the gameplay, the system can transition back to presenting guidance to players privately through their corresponding peripheral device, thereby transitioning the gameplay from an “open hand” to a closed hand and preserving competition in the gameplay.

However, the game console, instances of the virtual private game portal, and/or the remote server can function in any other way to generate and present guidance to one or more players throughout a gameplay.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method for executing an instance of a virtual multiplayer game comprising:
at a game console comprising a main display, receiving a selection of a game from a set games;
detecting a set of peripheral devices proximal the game console;
associating each peripheral device in the set of peripheral devices with a player at the game console;
during an instance of the game:
rendering a virtual public game environment on the main display;
distributing a first set of private data to a first peripheral device for presentation on a display of the first peripheral device, the first set of private data specific to a first player, the first peripheral device associated with the first player;
distributing a second set of private data to a second peripheral device for presentation on a display of the second peripheral device, the second set of private data specific to a second player and unique to the first set of private data, the second peripheral device associated with the second player;
during a turn assigned to the first user, receiving a play submitted by the first user at the first peripheral device; and
updating the virtual public game environment rendered on the main display based on the play.

2. A method for executing an instance of a virtual multiplayer game comprising:
at a game console, detecting a set of peripheral devices proximal the game console;
accessing a player account based on player identification data received from each peripheral device in the set of peripheral devices;
for peripheral devices in the set of peripheral devices, aggregating sets of games linked to corresponding player accounts into a composite set of available games;
at the main display, prompting selection of a game from the composite set of available games;
in response to receiving a selection for a particular game in the composite set of available games, initiating an instance of the particular game at the game console and at peripheral devices in the set of peripheral devices;
presenting private player data for the particular game to select players through corresponding peripheral devices in the set of peripheral devices; and
presenting public game data within a virtual public game environment rendered on the main display.

3. A method for executing an instance of a virtual multiplayer game comprising:
at a game console, receiving a selection for a game;
identifying a group of players though a set of peripheral devices in communication with the game console;
identifying a particular player, in the group of players, exhibiting less experience playing the game than other players in the group of players;
rendering a virtual public game environment on the main display;
at a first time, at a particular peripheral device associated with the particular player, issuing a prompt for a first game action based on a state of the virtual public game environment;
at the game console, updating the virtual public game environment on the main display based on the first game action submitted by the particular player;
in response to submission of the first game action by the particular player, recording a milestone for the first game action; and
at a second time succeeding the first time, withholding a prompt for the first game action from the particular player based on the milestone.
